(19) United States
(12) Patent Application Publication
(10) Pub. No.: US 2025/0345702 A1
(43) Pub. Date: Nov. 13, 2025

(54) METHOD FOR GENERATING A GAME RESULT BASED ON A SET OF GAME RULES

(71) Applicant: TABLESCOPE GmbH, Graz (AT)

(72) Inventors: Emanuele SANTELLANI, Graz (AT); Leonardo ALESE, Graz (AT)

(73) Assignee: TABLESCOPE GmbH, (US)

(21) Appl. No.: 18/550,821

(22) PCT Filed: Mar. 17, 2022
(86) PCT No.: PCT/AT2022/060077

§ 371 Date: May 13, 2024

(30) Foreign Application Priority Data
Mar. 18, 2021 (AT) A54-2021

(51) Int. Cl. A63F 11/00; A63F 9/24; G06T 7/70; G06T 13/80

(52) U.S. Cl. CPC A63F 11/0074; A63F 9/24; G06T 7/70; G06T 13/80; A63F 2009/2433; A63F 2009/2435; A63F 2009/2447; A63F 2011/0086; A63F 2250/287

(57) ABSTRACT

A method for generating a game result based on a game rule set with predetermined game rules and at least one image recording of a plurality of game objects on a game field includes: recording at least one image recording of the plurality of game objects on the game field with a recording device, evaluating the at least one image recording with respect to an alignment and/or position of the game objects on the game field and/or with respect to one another, evaluating the at least one image recording with respect to the type of playing objects, applying the game rule set to the evaluated at least one image recording, and outputting a game result on the basis of the applied game rule set.

### CROSS-REFERENCE TO RELATED APPLICATIONS

The present application is a 35 U.S.C. § 371 National Stage patent application of International patent application PCT/AT2022/060077, filed on Mar. 17, 2022, which claims priority to Austrian patent application AT A54-2021, filed on Mar. 18, 2021, the entire contents of each of which are incorporated herein by reference.

### BACKGROUND

### 1. Field of the Disclosure

The present disclosure relates to a method for generating a game result based on a set of game rules, a creation method for creating a game rule set and a result device for carrying out a method according to the disclosure.

### 2. Description of Related Art

It is known that essentially two different methods are used to play games. On the one hand, there are classic real games, for example board games, card games or the like, which can be played by several players, on a game board or at a table. In the case of digital games, which can also be referred to as computer games, the entire game takes place digitally, i.e. on a computer, a mobile phone, a tablet or a similar technical device.

Players of classic table games often have less interest in computer games. However, in some table games complex game rules mean that the evaluation of individual game rounds or the generation of a game result is very time-consuming and tedious. While this can take place automatically in computer games, in table games points have to be counted, cards have to be compared with each other or the like. Even though the evaluation of a game round or an entire game can be part of the appeal of playing the table game, it often leads to an increased effort and inconvenience to the players when playing such table games.

### SUMMARY OF THE DISCLOSURE

It is the object of the present disclosure to remedy, at least partially, the above disadvantages. In particular, it is the object of the present disclosure to provide, in a cost-effective and simple manner, a method which simplifies the evaluation of individual game rounds and/or the entire game in real table games.

The above object is achieved by a method and a result device according to the present disclosure. Naturally, features and details described in connection with the method according to the disclosure also apply in connection with the creation method according to the disclosure and the result device according to the disclosure and vice versa, so that, with regard to disclosure, mutual reference is or can always be made to the individual aspects of the disclosure.

According to the disclosure, a method for generating a game result based on a game rule set with predetermined game rules is proposed. For this purpose, the method is based on at least one image recording of a plurality of real game objects on a game field. Such a method comprises the following steps:
recording at least one image recording (BA) of the plurality of game objects (SO) on the game field (SF) with a recording device (10),
evaluating the at least one image recording (BA) with respect to an alignment and/or position of the game objects (SO) on the game field (SF) and/or with respect to one another,
evaluating the at least one image recording (BA) with respect to the type of game objects (SO),
applying the game rule set (SRS) to the evaluated at least one image recording (BA),
outputting a game result (SR) on the basis of the applied game rule set (SRS).

A method according to the disclosure serves to simplify, accelerate and/or make more accurate the evaluation of a game round or an entire game. This is explained in more detail below using an example of a card game.

For example, a table game may have cards as game objects which have differently printed upper sides. Depending on which motif is printed on the upper side of the respective card, this card, as a game object, has a different meaning for and/or effect on other game objects. The table game can for example consist of the individual players laying the individual playing cards in a defined order on a playing surface in the form of a game board or a table surface. In order to be able to evaluate which player has the most points after completing this laying process, game rules must be applied. While according to usual procedures the players have now manually compared and evaluated the positioning of the individual playing cards relative to each other, the type of the respective playing cards or the like, this can now be made much easier by a method according to the disclosure. For example, with a method according to the disclosure it is now possible to use a recording device to create an image recording of the plurality of game objects on the game field after completing a game round or the complete game. This image recording can be a photo, a video or the like. The image recording thus represents a visual reproduction of the current correlation between the individual game objects on the game field. In a next step, this image recording is evaluated in a method according to the disclosure. On the one hand, an evaluation is carried out as to how the individual game objects are aligned on the game field and/or in relation to each other. Alternatively or additionally, it is also possible to record one or more relative positions and/or even absolute positions of one or more game objects during the evaluation. In a further evaluation step, the image recording is evaluated with respect to the type of the individual game objects. In the example described, this can be an evaluation of the printed upper side of the game objects in order to distinguish different game objects from each other.

This evaluation is carried out automatically, for example in that an image analysis process is carried out within the recording device, a separate device or in a separate cloud or server device. This image analysis makes it possible to recognise game objects as such and define their type, alignment and/or position in the two evaluation steps.

The evaluation information from these evaluation steps is now available for the subsequent application of the game rule set. The game rule set can comprise the individual game rules governing the playing of the game. Such a game rule set can also contain information on different game functionalities of individual game objects based on their type, position and/or alignment.

The application of the game rule set thus means that the corresponding game rules are applied depending on the game being played, so that an evaluation of the current game situation is automatically made based on the alignment, position and/or type of the game objects on the basis of the game rule set applied. The application can also take place within the recording device, a separate device, in a cloud and/or a server device.

Finally, this evaluation can be output as a game result on the basis of the applied game rule set. It is already easy to see here that different game rule sets can of course be applied for different game objects. Also, different game types can be stored in different game rule sets for the same game objects.

For example, it is possible that the individual game objects stand for attack or defence objects in a table game. Thus, it is possible to build an attack formation of these game objects and/or a defence formation through the real arrangement of these game objects. The effect of this attack or defence position is now automatically guaranteed by the evaluation steps and the application steps. In this example, the method according to the disclosure can recognise what kind of attack game objects are arranged on the game field, and where, and whether and in what way these attack game objects are aligned with defence game objects. The application of the game rule set now makes it possible for example to apply the strength of the attack, the quality of the attack with respect to the alignment or the like between the individual game objects and thus determine which attacks, by which attack game objects on which defence game objects, were successful.

Of course, the above explanation is only a simple example. More complex or completely different evaluations based on other game rules are of course also conceivable. For example, surface correlations of individual game objects, their number or significance with respect to the type of individual game objects or the like can be taken into account when applying the game rule set.

The output game result can represent the end of such a table game and for example the winner of this game. It is also conceivable that the method according to the disclosure is carried out round by round, in particular after each round of the table game, so that intermediate results are, accordingly, output as game results.

As can be seen from the above explanation, a method according to the disclosure can be applied to table games and provide a means of evaluation which is simpler and above all more convenient for the individual players. In contrast to the known solutions in real table games with manual evaluation, the automated evaluation according to the present disclosure can now be carried out on a digital level in that the recording device bases the evaluation steps, the application step and the output step on the image recording. At the same time however, the table game players do not have to forego their real gaming experience, since according to the disclosure only the evaluation of the respective game round or the entire game takes place digitally. The real game itself is independent of the method according to the disclosure and leads to the familiar real gaming enjoyment of the players of the table game. Furthermore, nor is it necessary for the players of the table game to play it completely digitally, for example on a computer. Rather, a method for generating the game result according to the disclosure means that the advantages of the automated and accelerated and/or more accurate generation of the game result on a computer can be combined with the enjoyment of a real table game.

It should also be noted that the present method according to the disclosure is not part of the game, but rather provides a means of evaluation for such a game. It thus uses technical means to automate a process which was previously carried out purely manually and, in this way, leads to an improvement in convenience for the players, so that they can concentrate on the game and the evaluation of the game can be carried out in an automated manner.

It should also be pointed out that in a method according to the disclosure the type of game, the goal of the game and other parameters of the game are irrelevant. The crucial core idea is that a method according to the disclosure is made available exclusively for the evaluation of a game round or a game result, so that not the game itself, but only the evaluation of the game with regard to a winner or other details is facilitated through the method according to the disclosure.

A method according to the disclosure can, for example, be integrated into a software solution, for example in the form of an app, on a tablet or a mobile phone. Using the camera optics of a mobile phone, it is then possible to create the image recording and then carry out the evaluation steps as well as the application of the game rule set either on this mobile phone or on a server device in the cloud.

It should also be pointed out that, in a method according to the disclosure, the evaluation of the alignment and in particular the position of the individual game objects is carried out in a relative way, i.e. preferably always relative to the game field and/or relative to other game objects. In particular, this means that the actual position of the recording device, i.e. its alignment when recording the image recording, is irrelevant for the evaluation steps. In particular, in order to allow a method according to the disclosure to be carried out in a particularly simple way, it can be ensured in this way that no special care and accuracy is required in order to record an image recording which is then further processed in accordance with the disclosure.

It should also be pointed out that the individual game objects can be optimised for the implementation of a method according to the disclosure. For example, special printing or other optical features are conceivable which make the types of individual game objects distinguishable from each other. Surfaces or structures of the game objects can also be designed in such a way that their position or alignment can be detected particularly easily by the subsequent evaluation routine. It should also be pointed out that the graphical evaluation of the image recording can be carried out through usual evaluations of two-or three-dimensional images. Use can thereby be made of corresponding image evaluation libraries, but an adaptation or a completely separate design of these evaluation routines can also be provided. As has already been explained, this image evaluation can be carried out locally on the recording device itself or centrally, for example on a server located in the cloud. Such image evaluation is robust in application and can in particular be applied to different orientations and/or recording qualities of the image recording. This also applies in particular to signs of wear and tear on the game objects over a longer period of use. Also, recording errors such as reflections and/or poor illumination of the image recording can be disregarded by the digital image evaluation.

Such image evaluation can in particular be based on the integration of a neural network. The training of the neural network can be carried out by means of machine learning and corresponding data sets which contain a large number of image recordings of the game objects. Such a neural network can also be equipped with a continuous learning effect, so that the user of a method according to the disclosure can assess the quality of the evaluation and in particular correct it. Corrections that have been made are preferably used for further training of the neural network.

If the image evaluation is not successful in the desired way, for example due to poor quality of the image recording, in an additional step of the method a request for a new recording of the image recording can be output and/or such a new recording of the image recording can take place automatically. It is also possible to check the quality of the image recording with regard to evaluability before evaluation and for example to compare the brightness, sharpness and/or framing with minimum requirements for the quality of the image recording. In the case of such a check, the new image recording can already take place and/or be requested before an evaluation attempt. Such a check is in particular carried out directly after the recording of the image recording if for example a user of the recording device is still holding this in a recording position, and/or before communicating the image recording to a server device for further evaluation.

In addition to the simplified and more convenient evaluation, a method according to the disclosure even makes possible game rules which would not be possible with purely “real” table games. So even new, previously impossible game ideas can be implemented. For example, when evaluating the image recording, reference can be made to hidden information, for example the purely digital game objects which will be explained later. Complex geometric evaluations can also be carried out on the basis of the automated image analysis which would be impossible for the players in reality, for example angular relationships between game objects or areas of the playing surface defined by game objects. In addition to the improvement of known games, the novel evaluation according to the disclosure also makes the development of new and previously impossible games conceivable.

It can be advantageous if, in a method according to the disclosure, the at least one image recording is also evaluated with respect to the relative positioning of the recording device in relation to the game objects and/or the game field. For example, the relative position of the recording device in relation to the game objects can be detected by forming corresponding correlations with fixed objects in a room. If, for example, the recording device includes a three-dimensional camera device and/or a lidar or the like, this additional information can further increase the accuracy in the evaluation of the image recording. The use of tripod devices or the like for the recording device is also fundamentally conceivable here.

It also brings advantages if, in a method according to the disclosure, all or substantially all steps of the method are carried out on the recording device, especially in the form of a mobile device. While parts of the evaluation can in principle be carried out outside of the recording device, for example in a server-based manner, it can be advantageous if as many as possible or even all of the method steps are carried out on the recording device itself. This also allows an evaluation to be carried out with a method according to the disclosure if there is no connection to a communication network. In particular, this is the case if, where a mobile device is used as recording device, the complete method sequence is integrated into the software running on this in the form of an app. If communication with a server is to be provided, this communication is preferably bidirectional, so that the image recording is sent to the server for evaluation and the evaluation result is received back from the server.

It can also be advantageous if, in a method according to the disclosure, the game objects comprise playing cards and/or gaming pieces. Of course, a combination of different forms of such two-dimensional or substantially two-dimensional game objects is also possible. The design and production of such playing cards and gaming pieces can be particularly simple and economical. Also, existing playing cards and/or game objects can be used as a starting point for a method according to the disclosure.

It can also bring advantages if, in a method according to the disclosure, the game objects comprise three-dimensional game objects. These too may be combined with the two-dimensional playing cards or gaming pieces referred to in the previous paragraph. Different degrees of complexity may be possible for such three-dimensional game objects. For example, figures or the like as game objects are conceivable within the framework of this embodiment. Preferably, such three-dimensional game objects have a flat base in order to ensure a defined and stable positioning and/or orientation. Further advantages can be achieved if, in a method according to the disclosure, the game result comprises at least one of the following components:
result score
winner of the game round
classification in a score list
intermediate result.

The above list is non-exhaustive. Of course, a game result can also comprise two or more individual components. It should also be pointed out that the game result may contain information about so-called hidden game objects, i.e. game objects which, as digital game objects, can be part of such a table game in addition to the real game objects. Another possibility is if, in the case of an intermediate result, this intermediate result contains additional information on how to proceed for the next subsequent round of the game. For example, instructions can be issued as to which steps should be carried out next or which game objects should be removed from the game field or relocated after this game round on the basis of the intermediate result. In the context of the present disclosure, an input from the user can also be requested here. For example, different options for the following round are conceivable when generating an intermediate result. The input means of the recording device can be used to enter the user's input, which includes a selection from the options offered.

It brings further advantages if, in a method according to the disclosure, the game objects are assigned to game object groups, in particular before the application of the game rule set. Such game object groups can for example be defined for the individual players of the table game. In this way, game objects of individual players can be assigned to the respective group of this player as a game object group. Different game objects can also be interpreted in terms of their effect on the basis of the game rule set and assigned to corresponding game object groups. Of course, it is also possible if, in the next step, not only the individual game objects, but also the corresponding game object groups to which the game objects have been assigned are taken into account in the evaluation.

It is also advantageous if, in a method according to the disclosure, the image recording is recorded as a result of a recording command, in particular at least one of the following:
voice command,
gesture command,
visual command.

The above list is non-exhaustive. In particular, this makes it possible to start the method according to the disclosure in a quasi-automated manner, or at least particularly simply. For example, a voice command can be the statement of a starting word for carrying out the method according to the disclosure. For example, one of the users can say aloud a defined start command which starts the recording of the image recording and thus the performance of the method according to the disclosure. Manual gestures, for example with the hand, within the field of view of the recording device, are also conceivable here. Other visual forms of command, such as a trigger card or a trigger object which is moved into the field of view of the recording device, can also be used here.

It is also advantageous if, in a method according to the disclosure, an animation of the game objects is displayed on a display device during the evaluation of the image recording, application of the game rule set and/or outputting of the game result. Such an animation is for example used to visualise the game rules and/or the game objects with regard to their effect and/or evaluation and to present the corresponding working steps of the method according to the disclosure to the players. If, for example, the individual game objects are designed to represent attack game objects and defence game objects in the table game, these individual attack and defence sequences can be visualised in an animated way on a display device on the recording device. It is also possible to animate the game result, for example to highlight the necessity to remove game objects for the next game round in an animated way in the game result.

It can also be advantageous if, in a method according to the disclosure, at least two image recordings are recorded by different recording devices, whereby in particular the different recording devices communicate with each other in the further course of the method. It is thus possible that the method according to the disclosure runs separately on different recording devices and that a plausibility check takes place through the communication of the recording devices with each other. Also, the quality and accuracy of the subsequent evaluation steps can be improved through different recording angles of the individual image recordings.

It is also advantageous if, in a method according to the disclosure, the image recording is prepared for evaluation. Such a preparation involves, in particular, a simplification and/or a pre-evaluation of the image recording. For example, areas with game objects can be retained in the image recording, while areas without game objects are removed from the image recording. This serves, for example, to reduce the data size of such an image recording and thus indirectly to accelerate the performance of a method according to the disclosure. The reduction of the image information in such a way is particularly advantageous if communication of the image recording to a server-side computing unit for further evaluation is to be guaranteed. The preparation can take place in the form of a single step or in several stages.

It is also advantageous if, in a method according to the disclosure, the game rule set to be applied is selected from a database containing a plurality of different game rule sets. Here again it is easy to see how a method according to the disclosure can be used in a universal way and is in particular designed independently of the actual structure of the game and the actual table game. Thus, it is possible that substantially any table game is simplified in terms of evaluation by a method according to the disclosure. The application to different table games can be flexibly adapted by selecting correspondingly different game rule sets from a database. Of course, this also applies to different game objects. For example, when used in a method according to the disclosure the game rule set has in particular two essential core areas. On the one hand, the type and functionality of the individual game objects are stored in the game rule set. On the other hand, information about the playing and evaluation of the table game is stored in the game rule set, so that the functionality of the individual game objects in relation to each other and the resulting results of the game objects for the respective game round are stored by applying the game rule set. This game rule set can be selected manually. However, it is also possible that, prior to the evaluation of the image recording, based on the type of game objects and/or their alignment, a probability is generated regarding the table game currently being played and, in this way, the appropriate game rule set is automatically selected or at least suggested. This is to be understood, in particular, as an automatic or substantially automatic selection of the game rule set. It is also possible that a game rule card placed in the field of view actively identifies the game and, in this way, selects the game rule set to be selected and applied by evaluating the image recording.

Further advantages can be achieved if, in a method according to the disclosure, the image recording is evaluated with respect to at least one digital game object which is not present on the real image recording, but is defined with respect to its alignment and/or position in relation to the real game objects. This is a further addition to the real table game in the form of a digital game object, which can also be referred to as a ghost object. If, for example, the game objects on the game field are defined as ships in the table game, in correlation to the game rule set, such digital game objects can represent submarines in the table game. In this case, the placement of further real game objects in the form of torpedoes or bombs can represent a part of the table game, so that the effect in the form of the digital game object being hit or missed by such a torpedo can be determined and output as a game result during the evaluation. The arrangement of these digital game objects can be effected by defined manual placement by means of the players, by a preset relation to the game field and/or game objects, but also by random positioning and alignment.

Another object of the present disclosure is a creation method for creating a game rule set for use in a method according to the disclosure, comprising the following steps:
providing an object recording of at least one game object,
defining at least one game rule of a game rule set with respect to the at least one game object.

A game rule set which is generated using such a creation method comprises at least one game rule and at least one more precisely defined game object. The game object is assigned to the table game in terms of its type and functionality and correlates with the at least one game rule in terms of its functionality with regard to the game result to be generated. The object recording can be recorded from a real existing game object, or it can also include a selection of a game object from a database. The implementation of the game rule set created in this way therefore does not require any knowledge of the actual evaluation routine and in particular does not require any programming skills with regard to an image evaluation of a method according to the disclosure. Rather, it is thus possible, in a very simple and cost-effective way, to implement new forms and types of games with new game rules and/or new game objects and to implement these in a method for generating game results according to the disclosure.

It can be advantageous if, in such a creation method, an adaptation recommendation is output based on the object recording and/or the at least one game rule. If, for example, an object recording is made for a game object which cannot adequately distinguish it from other game objects, an indication of a different/improved selection can be given here. For example, better distinguishing features can be found on the object recording which are output accordingly as an adaptation recommendation. The adaptation recommendation is in particular based on the evaluation algorithm for the image recording used in the subsequent method according to the disclosure. Conflicting game rules can also be checked and likewise output in an associated adaptation recommendation for the user of a creation method. The creation method preferably also runs on a recording device and/or at least partially on a downstream server device. The creator of a desired new table game can therefore develop a new table game in a particularly simple way and in particular without any programming knowledge, for example with a simple recording device, for example in the form of a mobile device, and implement this on the basis of new or already known game objects. It is also possible here to use existing data on game objects and/or object recordings from a database.

Another object of the present disclosure is a result device for generating a game result based on a game rule set with predetermined game rules and at least one image recording of a plurality of real game objects on a game field. Such a result device has a recording device for recording at least one image recording of the plurality of game objects on the game field with the recording device. Furthermore, an evaluation device is provided for evaluating the at least one image recording with respect to the alignment and/or position of the game objects on the game field and/or in relation to each other and evaluating the at least one image recording with respect to the type of game objects. The result device also has an application device for applying the game rule set to the evaluated at least one image recording as well as an output device for outputting a game result on the basis of the applied game rule set. The result device is preferably designed to carry out a method according to the disclosure and thus brings the same advantages as have been explained in relation to this method.

### BRIEF DESCRIPTION OF THE DRAWINGS

Further advantages, features and details of the disclosure are disclosed in the following description, in which exemplary embodiments of the disclosure are described in detail with reference to the drawings. In each case schematically:

FIG. 1 shows a first step of a method according to the disclosure,

FIG. 2 shows a result device according to the disclosure,

FIG. 3 shows another result device according to the disclosure,

FIG. 4 shows another result device according to the disclosure,

FIG. 5 shows a possibility of a relationship between game objects,

FIG. 6 shows a variation of the relationship shown in FIG. 5,

FIG. 7 shows a possibility of an assignment to game object groups,

FIG. 8 shows a possibility of an object recording,

FIG. 9 shows another possibility of an object recording and

FIG. 10 shows another possibility of an object recording.

### DETAILED DESCRIPTION OF THE DISCLOSURE

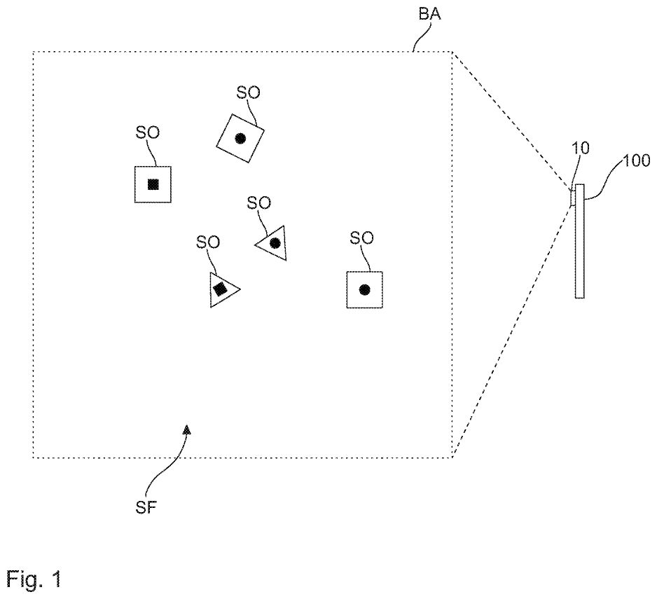

FIG. 1 shows schematically what the end of a first round of a card game might look like. Here, various game objects SO have been placed on a game field SF in the form of a table by the individual players. The game objects SO differ in their outer shape, i.e. a triangle or a square, and also in the arrangement of a central object in the form of a black circle or a black square. Thus, several different types of game objects SO are arranged on the game field SF.

In order to be able to carry out an evaluation with respect to a game rule set SRS, a method according to the disclosure is started on a result device 100, for example in this case a mobile phone. With the recording device 10, a two-dimensional image is generated as an image recording BA of the game field SF, so that an evaluation of the image recording BA can be made available subsequently. Optionally, the image recording BA can be prepared before evaluation, so that unwanted or unnecessary background information can be deleted. During the evaluation, the individual game objects SO can be distinguished from each other in terms of their alignment and/or position on the game field SF as well as in terms of their type, in the form of their outer contour, or in terms of the central black geometric shape. In the next step, after the evaluation, the game rule set SRS is applied and the result is displayed in the form of the output of the game result SR.

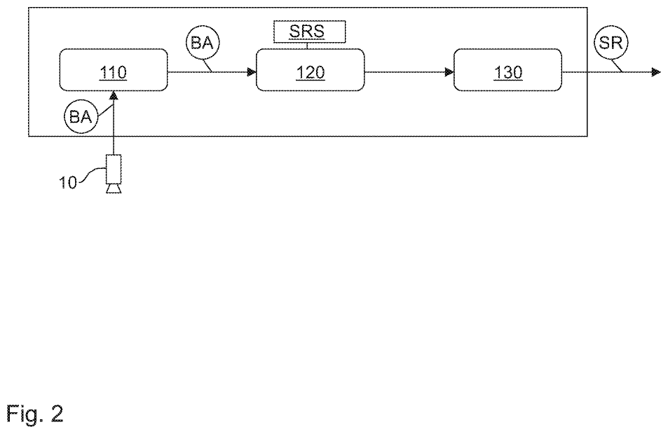

FIG. 2 shows schematically how such a method works in a result device 100. For example, the recording device 10 is shown here as a camera device which transfers the image recording BA to the evaluation device 110. The evaluated image recording BA is transferred to the application device 120, in which a game rule set SRS is now applied to the evaluation results. The game result SR for this game round or a corresponding intermediate result is output on the output device 130.

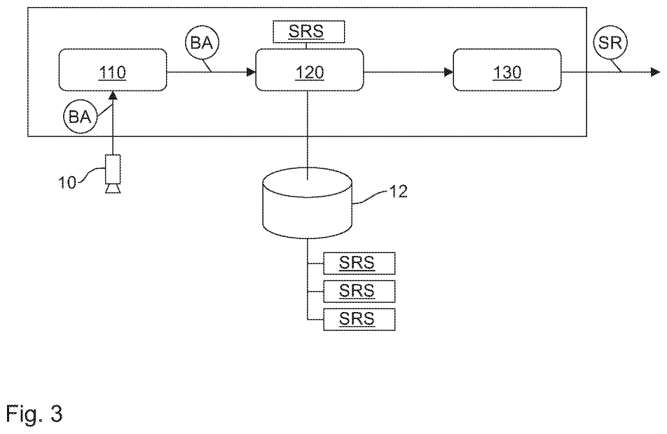

FIG. 3 shows the possibility of how such a result device 100 can be used for different game rule sets SRS in a method according to the disclosure. For example, a database is provided here in which a plurality of game rule sets SRS is stored. Which game rule set SRS is selected can be entered manually. An automatic selection or a selection based on a plausibility check is also conceivable here, as has already been explained.

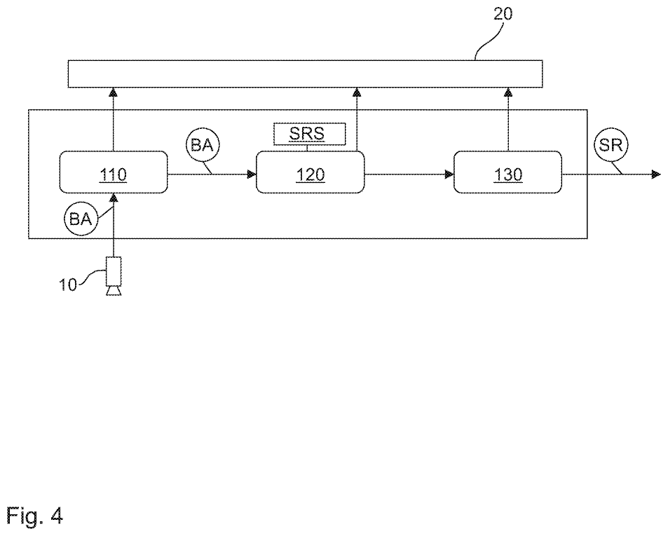

In FIG. 4, the result device 100 is equipped with a display device 20 on which the game result SR and/or animations can be carried out and displayed while carrying out the method and/or when outputting the game result SR.

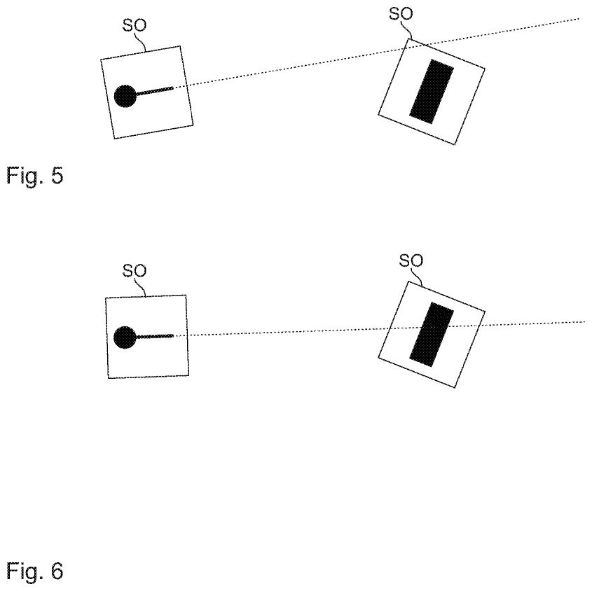

FIGS. 5 and 6 illustrate an example of how the evaluation and the application of a game rule set SRS can proceed in detail. In both FIGS. 5 and 6, two different game objects SO are shown. In terms of its function within the game, the game object SO on the left is an attack object which, shown in a dashed line, can carry out an attack shot. The game object SO on the right is designed here as a defence game object and can for example be wall-like in design. In contrast to a classic manual evaluation by the individual players, the evaluation in a method according to the disclosure now makes possible a very precise registration of the relative position and the relative alignment of the individual game objects SO in relation to each other. Thus, in particular, the two variants of FIGS. 5 and 6 can be distinguished very precisely from each other, i.e. the situation in FIG. 5, in which the attack shot by the game object SO on the left passes by the defending game object SO on the right, while according to the alignment in FIG. 6 this attack shot hits the defending game object SO on the right-hand side. Which effects this different alignment has on the game result SR must be taken into account when applying the game rule set, so that the game rule sets SRS can now apply the modes of action of the individual game objects SO to each other in order to determine the game result SR.

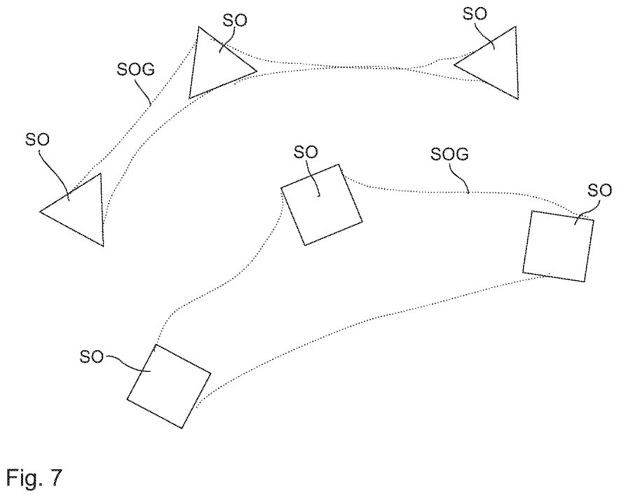

FIG. 7 shows a further embodiment of the present disclosure, wherein in an intermediate step, several identical game objects SO are each assigned to a game object group SOG. Here, the game objects SO differ in their geometric shape, one in the form of a triangle and one in the form of a square. The triangles are assigned to a first game object group SOG and the squares to a second game object group SOG. Depending on the applicable game rule set SR, the area swept by these game object groups SOG can also be taken into account in this evaluation when generating the game result SR.

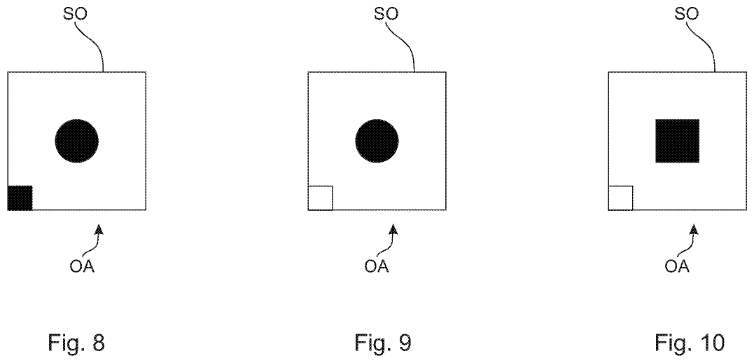

FIGS. 8, 9 and 10 show possibilities for an object recording OA. For example, when creating new game rule sets SRS, an object recording OA of real game objects SO, which are for example designed as shown in FIGS. 8 to 10, can be carried out. In a checking step, it now becomes possible to check whether the individual game objects SO of the object recording OA are clearly distinguishable from each other, i.e. as in FIGS. 8, 9 and 10 whether or not geometric shapes of the black and unfilled small circles and squares allow distinguishability. If such a distinguishability is not the case or is unlikely, a corresponding adaptation recommendation can be output to the creator of such a game rule set SRS.

The preceding explanation of the embodiments describes the present disclosure exclusively on the basis of examples. Naturally, individual features of the embodiments can, insofar as technically expedient, be combined freely with each other without departing from the scope of the present disclosure.

### LIST OF REFERENCE SIGNS

10 recording device
12 database
20 display device
100 result device
110 evaluation device
120 application device
130 output device
OA object recording
BA image recording
SR game result
SRS game rule set
SO game object
SOG game object group
SF game field

1. A method for generating a game result based on a game rule set with predetermined game rules and at least one image recording of a plurality of game objects on a game field, the method comprising:
recording at least one image recording of the plurality of game objects on the game field with a first recording device;
evaluating the at least one image recording with respect to an alignment and/or position of the game objects on the game field and/or with respect to one another;
evaluating the at least one image recording with respect to a type of the game objects;
applying the game rule set to the evaluated at least one image recording; and
outputting a game result based on the basis of the applied game rule set.

2. The method according to claim 1, further comprising:
evaluating the at least one image recording based on a relative positioning of the first recording device with respect to the game objects and/or the game field.

3. The method according to claim 1, wherein the entire method is carried out on the first recording device.

4. The method according to claim 1, wherein the game objects comprise playing cards and/or gaming pieces.

5. The method according to claim 1, wherein the game objects (SO) comprise three-dimensional objects.

6. The method according to claim 1, wherein the game result comprises at least one component selected from the group consisting of: a result score, a winner of a game round, a classification in a score list, and an intermediate result.

7. The method according to claim 1, wherein the game objects are assigned to game object groups.

8. The method according to claim 1, wherein the image recording is recorded in response to a command.

9. The method according to claim 1, further comprising:
displaying an animation of the game objects on a display device while evaluating the image recording, while applying the game rule set and/or while outputting the game result.

10. The method according to claim 1, further comprising:
recording at least a second image recordings with a second recording device that communicates with the first recording device while the method is performed.

11. The method according to claim 1, further comprising:
preparing the image recording for evaluation.

12. The method according to claim 1, wherein the game rule set that is applied is selected from a database containing a plurality of different game rule sets.

13. The method according to claim 1, further comprising:
evaluating the image recording with respect to at least one digital game object which is not present on the image recording but is defined with respect to its alignment and/or position in relation to the game objects.

14. A method for creating a game rule set for use in the method according to claim 1, the method comprising:
providing an object recording of at least one game object; and
defining at least one game rule set with respect to the at least one game object .

15. The method according to claim 14, further comprising:
outputting an adaptation recommendation based on the object recording and/or the at least one game rule.

16. A device for generating a game result based on a game rule set with predetermined game rules and at least one image recording of a plurality of game objects on a game field, the device comprising:
a recording device that records at least one image recording of the plurality of game objects on the game field;
an evaluation device that evaluates the at least one image recording with respect to an alignment and/or a position of the game objects on the game field and/or in relation to each other and that evaluates the at least one image recording with respect to a type of the game objects;
an application device that applies the game rule set to the evaluated at least one image recording; and
an output device that outputs a game result based on the applied game rule set.

17. The method according to claim 3, wherein the recording device is a mobile device.

18. The method according to claim 7, wherein the game objects are assigned to game object groups before application of the rule set.

19. The method according to claim 8, wherein the command is a voice command, a gesture command, and/or a visual command.
